(19) United States
(12) Patent Application Publication
(10) Pub. No.: US 2020/0299548 A1
(43) Pub. Date: Sep. 24, 2020

(54) IMIDAZOLIUM FLUOROSULFONYLIMIDE IONIC ADHESIVE COMPOSITIONS AND SELECTIVE DEBONDING THEREOF

(71) Applicant: NITTO DENKO CORPORATION, Osaka (JP)

(72) Inventors: Stanislaw Rachwal, Oceanside, CA (US); Tissa Sajoto, Carlsbad, CA (US); Yufen Hu, San Diego, CA (US); Hongxi Zhang, Temecula, CA (US); Peng Wang, San Diego, CA (US)

(21) Appl. No.: 16/765,663

(22) PCT Filed: Nov. 20, 2018
(86) PCT No.: PCT/US2018/061975

§ 371 Date: May 20, 2020

Related U.S. Application Data
(60) Provisional application No. 62/589,401, filed on Nov. 21, 2017.

(51) Int. Cl. C09J 4/00; C09J 7/30; C08K 5/3445; C08K 5/43; C09J 11/06; B32B 7/12; B32B 7/06; B32B 43/00; B32B 15/20

(52) U.S. Cl. CPC C09J 4/00; C09J 7/30; C08K 5/3445; C08K 5/43; C09J 11/06; B32B 2307/202; B32B 7/06; B32B 43/006; B32B 15/20; C09J 2205/302; C09J 2433/00; B32B 7/12

(57) ABSTRACT

An adhesive can include at least one imidazolium cation of Formula (1) and at least one fluorosulfonylimide anion of Formula (2). In these formulae: R¹ is a hydrogen, C₁-C₃ alkyl or an optionally substituted C₁-C₁₂ alkylamine, R₃ is each independently a C₁-C₃ alkyl or an optionally substituted C₁-C₁₂ alkylamine, and R², R⁴, R⁵ are each independently a hydrogen or a C₁-C₃ alkyl; Formula (1); Formula (2).

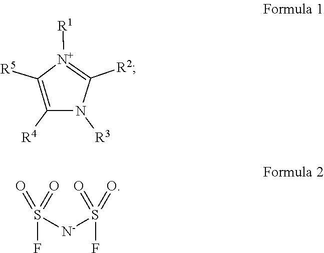

### CROSS-REFERENCE

This patent application claims priority to U.S. Provisional Application No. 62/589,401 filed Nov. 21, 2017, which provisional is incorporated herein by specific reference in its entirety.

### BACKGROUND

### Field

The present disclosure relates to compounds and/or materials for use as adhesives and coatings for application to surfaces, where the adhesives and coatings may be debonded from the surface without harm to that surface upon the application of an electromotive force. This disclosure also relates to methods for debonding adhesives and coatings from surfaces. More particularly, this disclosure relates to cationic imidazolium and anionic fluorosulfonylimide compositions for use in the adhesives and coatings.

### Description of Related Art

Ionic compositions, such as ionic liquids, may be useful as adhesives, such as adhesives for metal surfaces. However, it is known that compositions including some imidazolium sulfonylimides can be relatively corrosive to an aluminum surface.

Thus, there is a need for a new ionic composition that can be debonded from a surface without displaying the corrosiveness to metallic substrates.

### SUMMARY

In some embodiments, an adhesive composition can include: at least one imidazolium cation of Formula 1 and/or Formula 3:

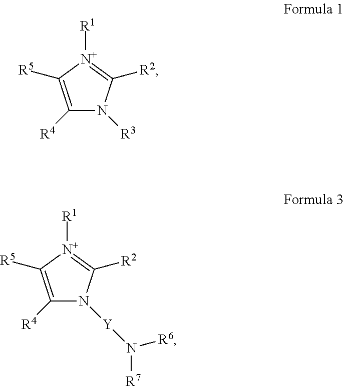

wherein: R¹ is a hydrogen, C₁-C₃ alkyl, or an optionally substituted C₁-C₁₂ alkylamine; R³ is a C₁-C₃ alkyl or an optionally substituted C₁-C₁₂ alkylamine; R², R⁴, R⁵, R⁶, and/or R⁷ are each independently a hydrogen or a C₁-C₃ alkyl; and Y is a linker.

The adhesive composition can also include at least one disulfonylimide anion of Formula 2 and/or Formula 4:

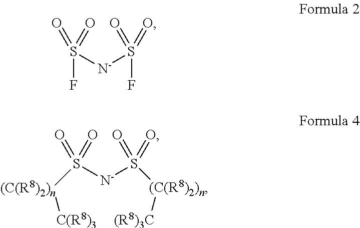

wherein: each R⁸ is individually a hydrogen or a fluorine; and n is an integer.

In some embodiments, an adhesive composition can include: at least one imidazolium cation of Formula 1:

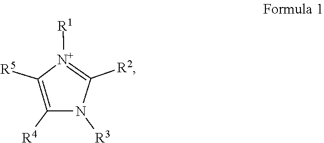

wherein: R¹ is a hydrogen, C₁-C₃ alkyl, or an optionally substituted C₁-C₁₂ alkylamine; R³ is a C₁-C₃ alkyl or an optionally substituted C₁-C₁₂ alkylamine; R², R⁴, R⁵ are each independently a hydrogen or a C₁-C₃ alkyl.

The adhesive composition can also include at least one fluorosulfonylimide anion of Formula 2:

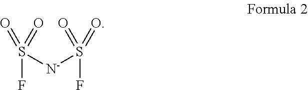

In some embodiments, the adhesive composition can be defined by: R¹, R², R⁴ and R⁵ are each independently a hydrogen, methyl, ethyl, or propyl; Y is a C₁-C₁₂ alkyl, substituted or unsubstituted, with or without hetero atoms; and n is 0, 1, 2, 3, or 4.

In some embodiments, the adhesive composition can be defined by at least one of the R¹ or R³ being the following:

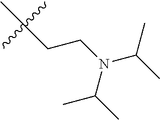 [SMILES: *CCN(C(C)C)C(C)C]

In some embodiments, the imidazolium cation is at least one of the following:

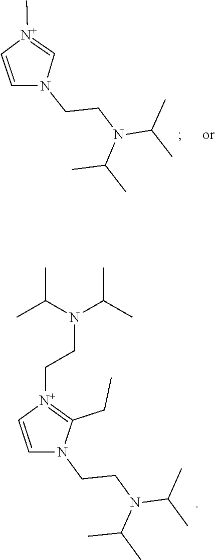

In some embodiments, the R² is methyl, ethyl, or propyl, where ethyl may be an example.

In some embodiments, the adhesive composition of one of the embodiments can include a polymer containing the imidazolium cation and the fluorosulfonylimide anion. In some aspects, the polymer includes at least one polymer selected from an acrylate polymer, alkylacrylate polymer, an alkyl-alkylacrylate ester polymer, or a combination thereof. In some aspects, the polymer comprises an acrylate polymer, a methacrylate polymer, or a combination of both acrylate and methacrylate polymers. In some aspects, the polymer comprises acrylic acid, C₁₋₁₄ hydrocarbyl acrylate, C₁₋₁₄ hydrocarbyl methacrylate monomers, or a combination thereof. In some aspects, the polymer is crosslinked. In some aspects, the polymer is crosslinked with an epoxy crosslinker. In some aspects, the epoxy crosslinker is N,N,N′,N′-tetraglycidyl-m-xylenediamine.

In some embodiments, the imidazolium cation and fluorosulfonylimide anion are present in about a 1:1 ratio.

In some embodiments, the adhesive composition is configured to be selectively debondable. In some aspects, the adhesive composition is configured to be selectively debondable under application of an electromotive force.

In some embodiments, a method of preparing the adhesive composition of one of the embodiments can include: combining the fluorosulfonylimide anion with the imidazolium cation. In some aspects, the method can include combining the fluorosulfonylimide anion and the imidazolium cation with a polymer. In some aspects, the method can include crosslinking the polymer before, during or after being combined with the fluorosulfonylimide anion and the imidazolium cation.

In some embodiments, a method of adhering the adhesive composition of one of the embodiments to a substrate can include: applying the adhesive composition to a first electrically conductive substrate. In some aspects, the method can further include applying the adhesive composition to a second electrically conductive substrate such that the adhesive composition is between the first electrically conductive substrate and the second electrically conductive substrate.

In some embodiments, an adhesive member can include: the adhesive composition of one of the embodiments formed into an adhesive layer; and at least one release liner on at least one side of the adhesive layer. In some aspects, the adhesive member can include a release liner on each side of the adhesive layer.

In some embodiments, a selectively adhesive material can include the adhesive composition of one of the embodiments configured such that application of an electromotive force to the selectively adhesive material reduces the adhesion of the selectively adhesive material.

In some embodiments, a selectively debondable structure can include a selectively debondable layer of the selectively adhesive material of one of the embodiments, wherein the selectively debondable layer is disposed between a first electro-conductive surface and a second electro-conductive surface. In some aspects, the selectively adhesive material adheres to the first electro-conductive surface and the second electro-conductive surface. In some aspects, the selectively debondable structure of one of the embodiments can include a power supply that is in electrical communication with at least one of the first electro-conductive surface and the second electro-conductive surface, creating a closeable electrical circuit therewith. In some aspects, the power supply is a DC power supply, which may provide about 3 volts to about 100 volts. In some aspects, the selectively debondable structure of one of the embodiments, can include the first electro-conductive surface having an electro-conductive material, which can be configured as a substrate. In some aspects, the selectively debondable structure of one of the embodiment can include the second electro-conductive surface having an electro-conductive material, which can be configured as a substrate. In some aspects, the electro-conductive material includes a metal, a mixed metal, an alloy, a metal oxide, a composite metal, a conductive plastic or a conductive polymer. In some aspects, the electro-conductive material includes an electro-conductive metal, a mixed metal, an alloy, a metal oxide, a mixed metal oxide, a conductive plastic, a carbonaceous material, a composite metal, or a conductive polymer. In some aspects, the electro-conductive material includes an electro-conductive metal. In some aspects, the electro-conductive metal includes aluminum. In some aspects, the selectively adhesive material has a reduced corrosive effect upon the first electro-conductive surface and/or second electro-conductive surface.

In some embodiments, a selectively debondable structure can include a selectively debondable layer of the selectively adhesive material of one of the embodiments, wherein the selectively debondable layer is disposed on a first electro-conductive surface. In some aspects, the selectively debondable structure of one of the embodiments can include a power supply that is in electrical communication with the first electro-conductive surface.

In some embodiments, a selectively debondable material can include the ionic compositions and/or adhesive compositions of one of the embodiments. In some aspects, the selectively debondable material can include a polymer. In some aspects, the polymer can include an acrylate polymer, a methacrylate polymer, or a combination of both acrylate and methacrylate polymers. In some aspects, the polymer can include acrylic acid, C1-14 hydrocarbyl acrylate or C1-14 hydrocarbyl methacrylate monomers. In some aspects, the selectively debondable material is an adhesive.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 is a schematic of a device incorporating an embodiment of an ionic composition described herein.

FIG. 2 is a schematic of a device incorporating an embodiment of an ionic composition described herein.

FIG. 3 is a schematic of a device used in testing the adhesion quality of the embodiments of ionic composition described herein.

FIG. 4 is a graph showing a peeling strength density vs. time plot of an embodiment of a compound described herein being tested in the device shown in FIG. 3.

The elements and components in the figures can be arranged in accordance with at least one of the embodiments described herein, and which arrangement may be modified in accordance with the disclosure provided herein by one of ordinary skill in the art.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally, the present technology includes compounds and/or materials for use as adhesives and coatings for application to surfaces, where the adhesives and coatings may be debonded from the surface without harm to that surface upon the application of electromotive force. The present technology also includes methods and systems for debonding adhesives and coatings from substrate surfaces. Additionally, the present technology includes cationic imidazolium and anionic sulfonylimide compositions for use in the adhesives and coatings.

In some embodiments, the ionic compositions described herein can be used for bonding to a surface. In some aspects, the ionic compositions can be configured as adhesives or coatings for a surface that when applied bond to the surface, the adhesive or coatings on the surface can be removed therefrom by a debonding procedure. The ionic composition is configured such that after being bonded to the surface, it can be removed without damaging the surface. This can be beneficial to allow for adhesives or coatings to be removed from a surface to retain the surface in pristine condition. The debonding procedure can include applying electricity, such as via an electromotive force, to allow for the adhesive or coating to lift from the surface without damaging the surface.

Additionally, the ionic composition described herein can be configured such that it is substantially less corrosive to metallic substrates than previous ionic compositions. The ionic composition can now be applied to a metallic surface of a substrate without causing the substrate to corrode. This can provide substantial benefit by allowing for more types of surfaces, such as on metallic substrates to receive an ionic composition as an adhesive or coating that are selectively debondable while reducing corrosion compared to prior compositions.

In some embodiments, the ionic composition can include an imidazolium cation, which includes an imidazole core structure, and thereby can be referred to as an imidazole or imidazolium that may or may not be substituted. The imidazolium cation of the ionic composition can include a structure under Formula 1 provided as follows:

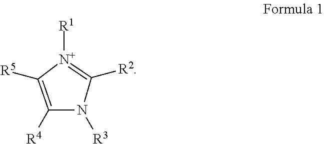

The structure of Formula 1 can include any substituent R group for R¹, R², R³, R⁴, and/or R⁵, such as those described herein or otherwise known.

With respect to any relevant structural representation, such as Formula 1, in some embodiments, R¹ is H, C₁-C₃ alkyl (such as methyl, ethyl, propyl, isopropyl, etc.) or an optionally substituted C₁-C₁₂ alkylamine. In some embodiments, R¹ is a C₁ alkyl. In some embodiments, R¹ is a 1-(2-(diisopropylamino)ethyl).

With respect to any relevant structural representation, such as Formula 1, in some embodiments, R² is H or a C₁-C₃ alkyl (such as methyl, ethyl, propyl, isopropyl, etc.). In some embodiments, R² is H. In some embodiments, R² is a C₂ alkyl.

With respect to any relevant structural representation, such as Formula 1, in some embodiments, R³ is a C₁-C₃ alkyl (such as methyl, ethyl, propyl, isopropyl, etc.) or an optionally substituted C₁-C₁₂ alkylamine. In some embodiments, R³ is a 1-(2-(diisopropylamino)ethyl).

With respect to any relevant structural representation, such as Formula 1, in some embodiments, R⁴ is H or a C₁-C₃ alkyl (such as methyl, ethyl, propyl, isopropyl, etc.). In some embodiments, R⁴ is H.

In some embodiments of Formula 1, the R groups can be defined as follows: R¹ can be a hydrogen, C₁-C₃ alkyl or an optionally substituted C₁-C₁₂ alkylamine; R², R⁴, and R⁵ can each independently be a hydrogen or a C₁-C₃ alkyl; and R³ can be a C₁-C₃ alkyl or an optionally substituted C₁-C₁₂ alkylamine.

In an example, an ionic composition under Formula 1 can include: R¹ is a C₁ alkyl; R² is a hydrogen; R³ is a 1-(2-(diisopropylamino)ethyl); and R⁴ and R⁵ both are hydrogen.

In another example, an ionic composition under Formula 1 can include: R¹ is a 1-(2-(diisopropylamino)ethyl); R² is a C₂ alkyl; R³ is a 1-(2-(diisopropylamino)ethyl); and R⁴ and R⁵ are both hydrogen.

In some embodiments, the R¹, R², R³, R⁴ and/or R⁵ substituents can each independently include a hydrophilic functional group. In some embodiments, at least one of R¹, R², and R³ substituents can include hydrophilic functional group. In some embodiments, the hydrophilic functional group can comprise nitrogen, sulfur and/or phosphorous. In some embodiments, the hydrophilic functional group can comprise an amino group. In some aspects, the R¹, R², and/or R³ substituents can each independently include a hydrophilic functional group. In some aspects, the R¹ and/or R³ substituents can each independently include a hydrophilic functional group.

In some embodiments, the R¹, R², R³, R⁴ and/or R⁵ substituents can each independently include a hydrophilic functional group that includes one or more of the following: amino, mono- and di-(alkyl)-substituted amino, mono- and di-(aryl)-substituted amino, alkylamido, arylamido, imino, alkylimino, arylimino, nitro, nitroso, sulfo, sulfonato, alkylsulfanyl, arylsulfanyl, alkylsulfinyl, arylsulfinyl, alkylsulfonyl, arylsulfonyl, phosphono, phosphonato, phosphinato, phospho, phosphino, hydroxyl, and combinations thereof, which may further include at least one C₁-C₃ alkyl coupled thereto so as to form the hydrophilic functional group. In some embodiments, at least one of the R¹, R², and R³ substituents can include the hydrophilic functional group. In some aspects, the R¹, R², and/or R³ substituents can each independently include a hydrophilic functional group. In some aspects, the IV and/or R³ substituents can each independently include a hydrophilic functional group.

In some embodiments, the R¹, R², R³, R⁴ and/or R⁵ substituents can each independently include a hydrophobic functional group. In some embodiments, at least one of the R¹, R², and R³ substituents can include a hydrophobic functional group. In some embodiments, the hydrophobic functional group can comprise an optionally substituted alkyl group. In some embodiments, the optionally substituted alkyl group can comprise a methyl, ethyl, and/or propyl group. In some aspects, the R¹, R², and/or R³ substituents can each independently include a hydrophobic functional group. In some aspects, the R¹ and/or R³ substituents can each independently include a hydrophobic functional group. In some aspects, the R² substituent can include a hydrophobic functional group.

In some embodiments, the imidazolium cation can include a first amine as one or more of the substituents. In some embodiments, the first amine can be an aliphatic amine. In some embodiments, the aliphatic amine can have two substituent groups, such as the R groups defined herein (e.g., R⁶ and/or R⁷). In some embodiments, the aliphatic amine can include an amino group.

In some embodiments, in addition to the first amine the imidazolium cation can include a second amine. In some embodiments, the second amine can include an aryl amine. In some embodiments, the aryl amine can have two substituent groups, which can be at least two of R¹, R², R³, R⁴ and/or R⁵, preferably R¹ and R² in addition to the first amine at one of the other R groups. In some embodiments, the aryl amine can be the imidazolium group. In some embodiments, the imidazolium group can include substituents at only R¹, R², and R³, where R⁴ and R⁵ are hydrogen.

In some embodiments, R¹ and/or R³ can include alkyl, such as methyl, ethyl, or propyl.

In some embodiments, R¹ and/or R³ can include the following substituent:

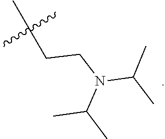 [SMILES: *CCN(C(C)C)C(C)C]

In some embodiments, R² can include an alkyl, such as methyl, ethyl, or propyl.

In some embodiments, the imidazolium cation can be selected from the following structures:

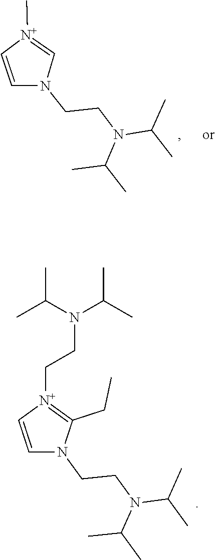

In some embodiments, the ionic composition can have one or more different types of imidazolium cations, such as one or both of the aforementioned structures.

In some embodiments, the ionic composition can include a sulfonylsulfonic imide anion. In some embodiments, the sulfonylsulfonic imide anion can include a fluoroalkylsulfonylimide compound (e.g. CH₂FSO₂NSO₂CH₂F, CF₃SO₂NSO₂CF₃, etc.). In some embodiments, the sulfonylsulfonic imide anion can comprise a fluorosulfonylimide compound.

Accordingly, the ionic composition may also include a sulfonylimide anion. The sulfonylimide anion can include a structure under Formula 2 as provided as follows:

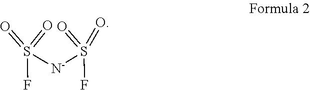

In some embodiments, the ionic composition can include the imidazolium cation and the sulfonylimide anion.

In some embodiments, the ionic composition can include a cation having an imidazolium linked through a linker to an amino group, which can be referred to as an imidazolium amino. The imidazolium amino cation of the ionic composition can include a structure under Formula 3 provided as follows:

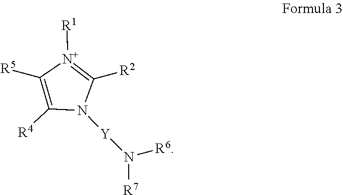

The structure of Formula 3 can include any substituent R group for R¹, R², R⁴, R⁵, R⁶, and/or R⁷ such as those described with respect to Formula 1 or otherwise described herein or otherwise known.

In some embodiments of Formula 3, the R groups can be defined as follows: R¹ can be a hydrogen, C₁-C₃ alkyl (e.g. methyl, ethyl, propyl, isopropyl, etc.) or an optionally substituted C₁-C₁₂ alkylamine; R², R⁴, R⁵, R⁶, and/or R⁷ can each independently be a hydrogen or a C₁-C₃ alkyl (e.g. methyl, ethyl, propyl, isopropyl, etc.), and Y can be a linker.

In some embodiments, Y is a linker, meaning a bond between the nitrogen atoms or a chain having one or more chain atoms. In some embodiments, Y is a linker of at least one chain atom. When Y is one chain atom or more than one chain atom, there may be a R⁷ substituent, such as defined herein, on one or more of the chain atoms. The linker can be a hydrocarbon chain with or without one or more hetero atoms, such as O, N, or S. The linker may include straight aliphatics, branched aliphatics, cyclic aliphatics, substituted aliphatics, unsubstituted aliphatics, saturated aliphatics, unsaturated aliphatics, aromatics, polyaromatics, substituted aromatics, hetero-aromatics, amines, primary amines, secondary amines, tertiary amines, aliphatic amines, carbonyls, carboxyls, amides, esters, amino acids, polymers, peptides, polypeptides, derivatives thereof, substituted or unsubstituted, or combinations. In some aspects, the linker can include C₁-C₂₄ alkyl, C₂-C₂₄ alkenyl, C₂-C₂₄ alkynyl, C₆-C₂₀ aryl, C₇-C₂₄ alkaryl, C₇-C₂₄ aralkyl, amino, mono- and di-(alkyl)-substituted amino, mono- and di-(aryl)-substituted amino, alkylamido, arylamido, imino, alkylimino, arylimino, nitro, nitroso, sulfo, sulfonato, alkylsulfanyl, arylsulfanyl, alkylsulfinyl, arylsulfinyl, alkylsulfonyl, arylsulfonyl, phosphono, phosphonato, phosphinato, phospho, phosphino, any with or without hetero atoms, derivatives thereof, and combinations thereof. In some aspects, the linker can include C₁-C₁₂ alkyl, C₂-C₁₂ alkenyl, or C₂-C₁₂ alkynyl, any with or without hetero atoms, derivatives thereof, and combinations thereof. In some aspects, the linker can include C₁-C₁₀ alkyl, C₂-C₁₀ alkenyl, or C₂-C₁₀ alkynyl, any with or without hetero atoms, derivatives thereof, and combinations thereof. In some aspects, the linker can include C₁-C₈ alkyl, C₂-C₈ alkenyl, or C₂-C₈ alkynyl, any with or without hetero atoms, derivatives thereof, and combinations thereof. In some aspects, the linker can include C₁-C₆ alkyl, C₂-C₆ alkenyl, or C₂-C₆ alkynyl, any with or without hetero atoms, derivatives thereof, and combinations thereof. In some aspects, the linker can include C₁-C₄ alkyl, C₂-C₄ alkenyl, or C₂-C₄ alkynyl, any with or without hetero atoms, derivatives thereof, and combinations thereof. In some aspects, the linker can include C₁-C₃ alkyl any with or without hetero atoms, derivatives thereof, and combinations thereof. In some aspects, the linker can include C₁-C₂ alkyl any with or without hetero atoms, derivatives thereof, and combinations thereof.

In some embodiments, the imidazolium cation can include a first amine as one or more of the substituents. In some embodiments, the first amine can be an aliphatic amine. In some embodiments, the aliphatic amine can have two substituent groups, such as the R groups defined herein (e.g., R⁶ and/or R⁷). In some embodiments, the aliphatic amine can include an amino group.

In some embodiments, in addition to the first amine the imidazolium cation can include a second amine. In some embodiments, the second amine can include an aryl amine. In some embodiments, the aryl amine can have two substituent groups, which can be at least two of R¹, R², R³, R⁴ and/or R⁵, preferably R¹ and R² in addition to the first amine at one of the other R groups. In some embodiments, the aryl amine can be the imidazolium group. In some embodiments, the imidazolium group can include substituents at only R¹, R², and R³, where R⁴ and R⁵ are hydrogen.

In some embodiments, the ionic composition can include the fluoroalkysulfonylimide compound having a structure as in Formula 4 provided as follows:

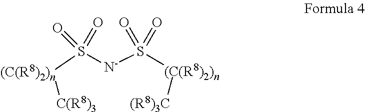

The structure of Formula 4 can include any substituent R group for each R⁸ independently, such as those described herein or otherwise known. Also, each n can be an integer, such as 0, 1, 2, 3, or 4, or other.

In some embodiments of Formula 4, each R⁸ can individually be hydrogen or a halogen. In some embodiments of Formula 4, each R⁸ can individually be hydrogen or a fluorine. In some embodiments, at least one R⁸ is a halogen, such as fluorine. In some embodiments, for each sulfonyl group, at least one R⁸ is a halogen, such as fluorine. In some embodiments, for each sulfonyl group, only one R⁸ is a halogen, such as fluorine.

In some instances, the ionic composition can include the imidazolium cation with or without the sulfonylimide anion (e.g., bis(fluorosulfonyl)imide). In some instances, the ionic composition can include the sulfonylimide anion with or without the imidazolium cation. In any configuration, the ionic composition can be used as the adhesive layer or coating layer, or other layer.

In some embodiments, the ionic composition can include a cation having an amino group, a linker and an imidazolium group, where the amino and imidazolium groups bound to each other by the linker (e.g., Y). In some embodiments, the cation may be a composition with an anion. In some embodiments, the anion may be bis(fluorosulfonyl)imide.

In some embodiments, the ionic composition is devoid of 1-ethyl-3-methyl-imidazolium bis(fluorosulfonyl)imide.

In some embodiments, the ionic composition described herein with the imidazolium cation and the bis(fluorosulfonyl)imide anion can be formulated as follows:

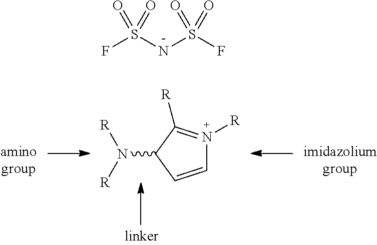

In this formulation, the amino group can include the R groups as defined herein, such as for R¹, R², R⁶ and/or R⁷ can be the hydrogen or substituents as defined herein. This formulation may also include the linker, which can be as defined for Y.

In some embodiments, the ionic composition described herein with the imidazolium cation and/or the sulfonylimide anion can be formulated with a polymer. The polymer can be selected based on the functionality thereof in view of the desired functionality. In some aspects, the polymer formulated in the ionic composition can include an acrylic polymer.

In some embodiments, the polymer formulated in the ionic composition, such as with the imidazolium cation and/or the sulfonylimide anion can be a polymer suitable for use as the adhesive or coating that is selectively debondable, such as by applying the debonding process to the adhesive or coating. The suitable polymer can include the polymers described in WO2017/064918 and/or JP2017-075289, which are incorporated herein by specific reference in their entirety. In some aspects, the polymer can include a glass transition temperature below 0° C. In some aspects, the polymer can be an acrylic polymer. In some aspects, the acrylic polymer can include a monomer unit derived from a monomer of a formula R^{a}CH═CHCO₂R^{b}, wherein R^{a} is H or C₁₋₁₄ alkyl (e.g. methyl, ethyl, C₃ alkyl, C₄ alkyl, C₅ alkyl, C₆ alkyl, etc.), and R^{b} is H or C₁₋₁₄ alkyl (e.g. methyl, ethyl, C₃ alkyl, C₄ alkyl, C₅ alkyl, C₆ alkyl, etc.). In some embodiments, the polymer includes repeating units derived from acrylic acid, methyl acrylate, methacrylic acid, methylmethacrylate, or a combination thereof. In some aspects, the acrylic polymer can contain an alkyl-methacrylate ester and a monomer unit derived from a monomer that contains a polar group. In some aspects, the monomer containing the polar group (e.g., polar monomer) can be a monomer that contains a carboxyl group. In some aspects, the C₁-C₁₄ alkyl group containing alkyl-methacrylate ester is butyl-methacrylate ester, and may be methyl-methacrylate ester, ethyl-methacrylate ester, propyl-methacrylate ester, methyl-ethylacrylate ester, methyl-propylacrylate ester, methyl-butylacrylate ester, or other alkyl-alkylacrylate ester.

In some embodiments, the polymer may be crosslinked. The crosslinked polymer may include the polymer crosslinked with only polymers in the composition. In some aspects, the crosslinked polymer may chemically crosslink with the imidazolium. In some aspects, the crosslinked polymer may chemically crosslink with the fluorosulfonylimide. In some aspects, the crosslinked polymer may chemically crosslink with the imidazolium and fluorosulfonylimide. Crosslinkers that can crosslink the polymers can be selected based on the desired properties in order to provide the crosslinked polymer. The crosslinkers may be suitable for use with the alkyl-alkylacrylate esters. The crosslinker can be an epoxy crosslinker, such as N,N,N′,N′-tetraglycidyl-m-xylenediamine. However, it should be recognized that any suitable crosslinker may be used to crosslink the polymer. The crosslinker can be selected to retain the selective adhesive properties and selective debonding properties as described herein. The crosslinker can also be selected to retain the anticorrosive properties described herein.

Any suitable amount of ionic liquid may be used in the adhesive composition. In some embodiments, the ionic liquid or ionic compound is about 0.0-1%, about 1-2%, about 2-3%, about 3-4%, about 4-5%, about 5-6%, about 6-7%, about 7-8%, about 8-9%, about 9-10%, about 10-15%, about 15-20%, about 20-25%, about 25-30%, about 30-40%, about 40-50, about 50-100%, about 4.5-5%, or about 5% of the total weight of the ionic liquid plus the polymer.

In some embodiments, a device is described comprising any of the aforementioned compounds. A suitable example of such a device can be as described in JP 2017-075289 and/or WO2017/064925, which are incorporated herein by specific reference in their entirety. Accordingly, the device can be an electronic device that includes an electro-conductive substrate having the selectively adhesive compositions described herein. In some aspects, the device can include a battery.

The ionic composition can be used as a selectively debondable layer on a surface of a substrate, such as the adhesive layer or coating layer as described herein. In some aspects, the ionic composition configured as a selectively debondable layer can be positioned or otherwise located between two electro-conductive surfaces, such as between a first electro-conductive surface and a second electro-conductive surface. The selectively debondable layer formed from the ionic composition can be applied as an adhesive layer (e.g., selectively adhesive) between the first electro-conductive surface and the second electro-conductive surface, so as to adhere a first substrate having the first electro-conductive surface to a second substrate having the second electro-conductive surface. The adhesive layer may be considered to be selectively adhesive due to the debonding procedure that can be implemented to debond the adhesive layer from the first electro-conductive surface and/or the second electro-conductive surface. The debonding procedure can include applying electricity, such as via an electromotive force, to the first electro-conductive substrate and/or the second electro-conductive substrate to debond the adhesive layer therefrom. The debonding procedure can cause a reduction of adhesiveness in the adhesive layer so as to be less adhesive to the first electro-conductive surface and/or the second electro-conductive surface, which allows separating the adhesive layer therefrom. This also allows for the first electro-conductive surface to be separated from the second electro-conductive surface. Due to the ionic composition being less corrosive and the debonding procedure allowing for removal from the surfaces without damage, the surfaces can be retained in significantly improved conditions compared to prior adhesives. The improved condition can be beneficial for reuse of the substrates having the surfaces.

In some embodiments, the ionic composition can be configured to have reduced corrosion or no corrosion (e.g., unmeasurable or undetectable) for metal substrates, such as electro-conductive metal substrates.

In some embodiments, the ionic composition can be provided with the ingredients as described herein. In some aspects, the ionic composition has a reduced Lewis acidity. In some aspects, the ionic composition can include a suitable pH. In some aspects, the ionic composition can include a pH that is not overly acidic or overly basic. In some examples, the pH can range from about 5 to about 9, or about 6 to about 8 or about 7. When alkaline, the pH can range from about 7 to about 9, about 7.5 to about 8.5, or about 8.

The selectively debondable layer can be used in a selectively debondable structure that used to adhere two non-conductive materials to one another, and then release the bonding so that the debonded materials do not contain any conductive materials or layers. This type of structure comprises an electro-conductive layer with a selectively debondable layer adhered to each side. Each of these adhesive layers can then be adhered to a nonconductive material, thus providing adhesion between two nonconductive structures. An electromotive force can then be applied to the electro-conductive layer to reduce the adhesion in both adhesive layers. Thus, the two nonconductive structures can be adhered to one another, and then separated, without needing to first be bonded or attached to a conductive layer or material.

In some embodiments, the ionic composition can be provided with various ratios of the imidazolium cation with respect to the sulfonylimide anion. In some aspects, the molar ratios of the imidazolium cation:sulfonylimide anion can be 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 1:10-1:9, 1:9-1:8. 1:8-1:7, 1:7-1:6, 1:6-1:5, 1:5-1:4, 1:4-1:3, 1:3-1:2, 1:2-1:1, 1:1-2:1, 2:1-3:1, 3:1-4:1, 4:1-5:1, 5:1-6:1, 6:1-7:1, 7:1-8:1, 8:1-9:1, or 9:1-10:1. In one aspect, the ratio of the imidazolium cation:sulfonylimide anion can be 1:1, or substantially equivalent, such as being 0.1%, 0.5%, 0.75%, 1%, 2%, or 5% from being equivalent.

In some embodiments, the ionic composition can be provided so that the molecular weight is reduced. For example, the molecular weight may be less than 160 g/mole. This molecular weight can be for a substance formed from the imidazolium cation and/or sulfonylimide anion.

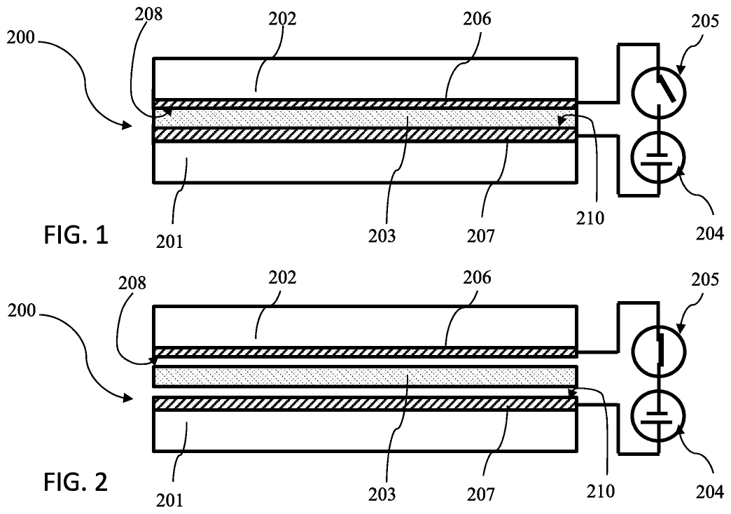

FIGS. 1 and 2 show a device 200 having a first electro-conductive substrate 206 having a first electro-conductive surface 208 and a second electro-conductive substrate 207 having a second electro-conductive surface 210. FIG. 1 shows a first stage with bonding where the selectively adhesive material 203 is positioned between and in contact (e.g., bonded) with the first electro-conductive surface 208 and the second electro-conductive surface 210. Accordingly, when bonded, the first electro-conductive surface 208 is adhered to a first side of the selectively adhesive material 203 and the second electro-conductive surface 210 is adhered to a second side of the selectively adhesive material 203.

FIG. 2 shows a second stage with debonding where the selectively adhesive material 203 is positioned between and not in contact (e.g., debonded) with the first electro-conductive surface 208 and second electro-conductive surface 210. Accordingly, when bonded, the first electro-conductive surface 208 is debonded from the first side of the selectively adhesive material 203 and the second electro-conductive surface 210 is debonded from the second side of the selectively adhesive material 203.

As shown in FIGS. 1 and 2, the selectively adhesive material 203 is configured as a selectively debondable layer that is disposed between the first electro-conductive surface 208 and the second electro-conductive surface 210.

The selectively adhesive material 203 can include the compounds of the ionic compositions described herein. As such, the selectively adhesive material 203 can be a selectively debondable layer or coating disposed between the first electro-conductive substrate 206 and the second electro-conductive substrate 207. The first electro-conductive substrate 206 having an electro-conductive surface 208 and the second electro-conductive substrate 207 having an electro-conductive surface 210, can respectively be each individually disposed upon two non-metal (non-electro-conductive) substrates or layers, 201 and 202.

The first electro-conductive substrate 206 and second electro-conductive substrate 207 may be in electrical communication with a power supply 204 (e.g., DC, but may be AC) to complete a closeable electrical circuit with an intervening switch 205, or may be attached to the power supply when debonding is desired. When the switch 205 is open, as shown in FIG. 1, there is no electromotive force so that the selectively adhesive material 203 is bonded to both the first electro-conductive surface 208 and the second electro-conductive surface 210, which can be metal coating-adhesive interfaces. When the switch 205 is closed, as shown in FIG. 2, an electromotive force is created wherein, the two substrates or layers 201 and 202 can separate from the selectively adhesive material 203, thereby the selectively adhesive material 203 is separated from both the first electro-conductive surface 208 and the second electro-conductive surface 210. The DC voltage can typically be from about 3V to about 100 V, but may be varied as needed or desired.

In some embodiments, the selectively adhesive material 203 can also be referred to as a selectively debondable layer due to the ability to have selective bonding without an electrical current or selective debonding with an electrical current. The material 203 can comprise a selectively adhesive material, which can be formed from the ionic compositions described herein. In some aspects, the material 203 can bind and connect the first electro-conductive surface 208 and the second electro-conductive surface 210 together, wherein the application of an electromotive force to the electro-conductive materials of the first electro-conductive substrate 206 or second electro-conductive substrate 207 reduces the adhesion of the material 203. In some aspects, the material 203 can include an ionic composition having a compound of at least Formula 1. In some embodiments, the material 203 can include an ionic composition having a compound of Formula 1 and a compound of Formula 2. In some instances, the ionic composition can include a compound of Formula 3 in place of the compound of Formula 1 or in addition thereto. In some instances, the ionic composition can include a compound of Formula 4 in place of the compound of Formula 2 or in addition thereto. As such, the ionic composition can include a cation of at least one of Formula 1 or Formula 3, with or without an anion of at least one of Formula 2 or Formula 4.

While not wanting to be bound by theory, it is believed that a movement of ions within the material 203 formed by the ionic composition may be effected by application of the electrical potential thereto. Upon a sufficient amount of movement being effected, such as sufficient ionic components being adjacent to the electro-conductive surface (e.g., 208 and/or 210), the adhesive qualities of the material 203 formed from the ionic composition is reduced, enabling separation of one or both of the electro-conductive surfaces 208, 210 from the material 203.

The selectively adhesive material 203 (e.g., also selectively debondable layer) incorporating the compounds of Formula 1 and/or Formula 3, with or without an anion of at least one of Formula 2 and/or Formula 4, can be a selectively debondable layer or coating disposed between the first electro-conductive substrate 206 and second electro-conductive substrate 207.

The first electro-conductive substrate 206 and second electro-conductive substrate 207 can be any electrically conductive material, such as a metal. An example of an electro-conductive metal that can be used for a first electro-conductive substrate 206 and second electro-conductive substrate 207 is aluminum. The electro-conductive material may include a conventional material such as a metal, mixed metal, alloy, metal oxide, mixed-metal oxide, a conductive polymer, a conductive plastic, or a conductive carbonaceous material. Examples of suitable metals include the Group 1 metals and Groups 4-15 metals. Examples of suitable metals include, but are not limited to, stainless steel, Al, Ag, Mg, Ca, Cu, Mg/Ag, LiF/Al, CsF, CsF/Al and/or alloys thereof. In some embodiments, the electro-conductive layers (e.g., first electro-conductive substrate 206 and second electro-conductive substrate 207) and/or the adhesive layer can each have a thickness in the range of about 1 nm to about 1000 μm, or 1 nm to about 100 μm, or 1 nm to about 10 μm, or 1 nm to about 1 μm, or 1 nm to about 0.1 μm, or 10 nm to about 1000 μm, or 100 nm to about 1000 μm, or 1 μm to about 1000 μm, or 10 μm to about 1000 μm, or 100 μm to about 1000 μm. In some aspects, the thickness can be from 20 nm to about 200 μm, or 100 nm to about 100 μm, or 200 nm to about 500 μm.

The two non-electro-conductive substrates or layers 201 and 202 can be any non-conducting material. Some examples can include non-conducting wood, cardboard, fiberglass density fiberboard, or plastic, as well as any other non-conducting material. In some aspects, the layers 201 and 202 can be electrical insulators. In some aspects, the layers 201 and 202 may be semiconductors. Any of the non-electro-conductive substrates 201 or 202 or semiconductor substrate (e.g., printed circuit board, PCB) can have any thickness and may be coupled to other substrates, materials or devices.

In some embodiments, the ionic composition, whether configured as an adhesive or a coating, of the selectively adhesive material 203 can have a reduced corrosive effect on the electro-conductive layers of the first electro-conductive substrate 206 or second electro-conductive substrate 207. The reduced corrosive effect can be comparable to the corrosive effect of other ionic compositions. Suitable protocols to assess the corrosive effect of the material 203 on the electro-conductive materials can include the procedures described in ASTM G69-12 (Standard Test Method for Measurement of Corrosion Potentials of Aluminum Alloys), which is incorporated herein by specific reference. Suitable alternative protocols to assess the corrosive effect of the ionic composition material 203 upon the electro-conductive materials of the first electro-conductive substrate 206 or second electro-conductive substrate 207 can be achieved by visually examining interface between the material 203 (e.g., adhesive) and the electro-conductive substrate (e.g., aluminum foil) for any indication of corrosive degradation of the substrate and/or dissolution of the material from the electro-conductive substrate (e.g., metal) into the material 203 and/or pitting of the surface of the electro-conductive substrate. If corrosiveness was observed, the time was recorded and the sample was indicated as corrosive, as shown in Table 1 below.

In some embodiments, the selectively adhesive material can be chemically stable with an electrically conductive electrode or electro-conductive materials. That is, the selectively adhesive material can avoid chemical degradation when applied to an electrically conductive electrode or electro-conductive materials, whether in the bonding stage with no electrical current, or in the debonding stage with electrical current. As such, the selectively adhesive material can be considered to have chemical stability during use. The stability of the selectively adhesive material can be maintained when located on aluminum, stainless steel, and/or combinations and/or mixtures thereof. In some aspects, the chemical stability of the selectively adhesive material is defined as lack of (or minimal presence) of undesired reactions between the electrically conductive material and the selectively adhesive material. Undesired reactions may include, for example, corrosive degradation of the electrically conductive material, dissolution of the electrically conductive material into the selectively adhesive material and/or pitting of the electrically conductive material.

In some embodiments, the presently described ionic composition formed as the selectively adhesive material when deposited on or in contact with the electro-conductive material may result in reduced or absence of corrosive degradation thereof. In some embodiments, direct contact of the neat ionic compound (e.g., imidazolium cation and/or sulfonylimide anion) or ionic composition or the selectively adhesive material formed from the ionic composition on the electro-conductive material may show an absence of or minimize any corrosive degradation thereof for a period of at least or greater than 15 minutes, 30 minutes, 1 hour, 3 hours, 5 hours, 7 hours, 24 hours, 50 hours, 100 hours, 125 hours, 200 hours, and/or 300 hours. In some aspects, direct contact of the neat ionic compound or ionic composition or selectively adhesive material on the electro-conductive material may minimize and/or prevent corrosive degradation thereof for one of the time periods described above. In some aspects, direct contact of the neat ionic compound or ionic composition or selectively adhesive material upon the electro-conductive material may minimize and/or prevent corrosive degradation thereof for periods described above in a 60° C./90% relative humidity (RH), 85° C./85% RH, or 90° C./80% RH environment, or any range therebetween for humidity and/or for temperature. In some aspects, a suitable protocol to exemplify an absence of any corrosive degradation can be by demonstrating a lack of total penetration into a surface of the electro-conductive material. In an example, the electro-conductive material can be an about 50 nm thick electro-conductive sheet of aluminum foil and the corrosive test can be performed for the above described time periods and/or environmental conditions.

In some embodiments, the selectively adhesive materials formed from the ionic compositions described herein can be formulated to minimize corrosion of the above described electro-conductive substrates under conditions of prolonged high humidity and high temperature. In particular, the adhesive composition is capable of maintaining two such electro-conductive substrates in fixed relation to each other during and after being subjected to aging. This resistance to corrosion has been validated by Accelerated Aging Test Method II, described herein, which can include exposure to 90° C./80% RH for a period of time described herein. The selectively adhesive materials can be fabricated using techniques known in the art, as informed by the guidance provided herein.

### EXAMPLES

It has been discovered that embodiments of ionic compositions and the selectively adhesive materials described herein can reduce the deterioration and/or corrosion of the electro-conductive materials (e.g., conductive metal layers) described herein. These benefits are further shown by the following examples, which are intended to be illustrative of the embodiments of the disclosure, but are not intended to limit the scope or underlying principles in any way.

### Synthesis of Ionic Compositions

### Example 1

Synthesis of 1-(2-(diisopropylamino)ethyl)-3-methyl-1H-imidazol-3-ium chloride can be performed as follows and shown in the first stage of reaction Scheme 1. Accordingly, 1-methyl-1H-imidazole (3.99 g, 48.6 mmol), 2-diisopropylaminoethyl chloride hydrochloride (10.21 g, 51.0 mmol), and sodium carbonate (14 g, 132 mmol) in dry acetonitrile (80 mL) were placed in a round-bottomed flask. The reaction mixture was refluxed under Argon for 24 h. After cooling to room temperature, the reaction mixture was filtered through Celite and the filtrate was concentrated under reduced pressure to obtain a crude product. Trituration of the residue with ethyl ether (100 mL) was performed. The white solids were filtered off, washed with ethyl ether (2×50 mL) and dried in a vacuum oven for 3 hours at 50° C. to give 1-(2-(diisopropylamino)ethyl)-3-methyl-1H-imidazol-3-ium chloride (10.36 g. 87% yield).

A combination of 1-(2-(diisopropylamino)ethyl)-3-methyl-1H-imidazol-3-ium and bis(fluorosulfonyl)imide (e.g., 1-(2-(diisopropylamino)ethyl)-3-methyl-1H-imidazol-3-ium bis(fluorosulfonyl)imide) can be formed as follows and shown in the second stage of reaction Scheme 1. A mixture of 1-(2-(diisopropylamino)ethyl)-3-methyl-1H-imidazol-3-ium chloride (5.0 g. 20.3 mmol), potassium-bis(fluorosulfonyl)imide (e.g., KFSI) (4.46 g, 20.3 mmol) and dry acetone (100 mL) was stirred under argon at 50° C. for 2 h. After cooling to room temperature, the solid was filtered off, and the solvent was removed under reduced pressure to give a crude product. Dichloromethane (100 mL) was added onto the crude product and it sat overnight. The fine white solids were filtered and the filtrate was concentrated under reduced pressure to give pure 1-(2-(diisopropylamino)ethyl)-3-methyl-1H-imidazol-3-ium bis(fluorosulfonyl)imide (7.64 g, 96% yield). 1H NMR (400 MHz, DMSO-d6) δ 9.03-8.97 (m, 1H), 7.73 (t, J=1.8 Hz, 1H), 7.67 (t, J=1.8 Hz, 1H), 4.10 (t, J=5.8 Hz, 2H), 3.87 (s, 3H), 2.96 (hept, J=6.6 Hz, 2H), 2.73 (t, 2H), 0.85 (d, J=6.6 Hz, 12H). The 1-(2-(diisopropylamino)ethyl)-3-methyl-1H-imidazol-3-ium bis(fluorosulfonyl)imide can be an ionically associated combination as the positive charge of 1-(2-(diisopropylamino)ethyl)-3-methyl-1H-imidazol-3-ium ionically associates (e.g., ionic bonding) with the negative charge of bis(fluorosulfonyl)imide to form a composition, which can be referred to as the T1 composition.

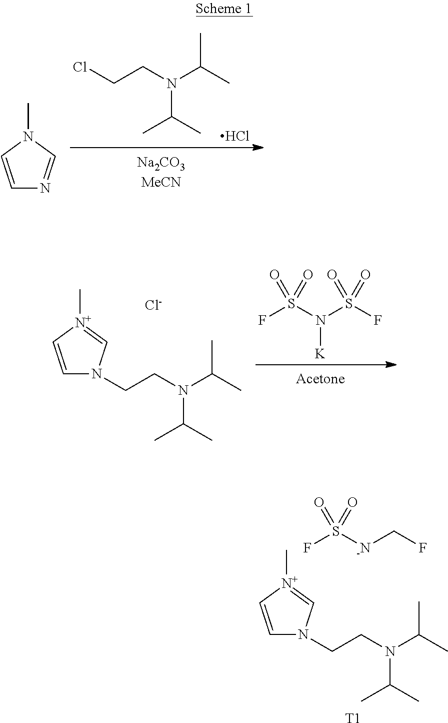

### Example 2

Synthesis of 1,3-bis(2-(diisopropylamino)ethyl)-2-ethyl-1H-imidazol-3-ium chloride can be performed as follows and shown in the first stage of reaction Scheme 2. Accordingly, 2-ethyl-1H-imidazole (4.67 g, 48.6 mmol), 2-diisopropylaminoethyl chloride hydrochloride (10.21 g, 51.0 mmol), and sodium carbonate (14 g, 132 mmol) in dry acetonitrile (80 mL) were placed in a round-bottomed flask. The reaction mixture was refluxed under Argon for 24 h. After cooling to room temperature, the reaction mixture was filtered through celite and the filtrate was concentrated under reduced pressure to obtain crude product. Trituration of the residue with ethyl ether (100 mL) was performed. The white solids were filtered off, washed with ethyl ether (2×50 mL), and further purified with recrystallization in MeCN and ethyl ether until mono-substituted product is no longer present. The purified product was dried in a vacuum oven for 3 hours at 50° C. to give 1,3-bis(2-(diisopropylamino)ethyl)-2-ethyl-1H-imidazol-3-ium chloride (3.35 g. 18% yield).

A combination of 1,3-bis(2-(diisopropylamino)ethyl)-2-ethyl-1H-imidazol-3-ium bis(fluorosulfonyl)imide can be performed as follows and shown in the second stage of reaction Scheme 2. A mixture of 1,3-bis(2-(diisopropylamino)ethyl)-2-ethyl-1H-imidazol-3-ium chloride (3.35 g. 8.65 mmol), KFSI (1.897 g, 8.65 mmol) and dry acetone (80 mL) was stirred under argon at 50° C. for 2 h. After cooling to room temperature, the solid was filtered off, and the solvent was removed under reduced pressure to give a crude product. Dichloromethane (100 mL) was added onto the crude product and it sat overnight. The fine white solids were filtered and the filtrate was concentrated under reduced pressure to give pure 1,3-bis(2-(diisopropylamino)ethyl)-2-ethyl-1H-imidazol-3-ium bis(fluorosulfonyl)imide (4.42 g, 96% yield). 1H NMR (400 MHz, DMSO-d6) δ 7.70 (s, 2H), 4.09 (t, J=5.9 Hz, 4H), 3.09 (q, J=7.6 Hz, 2H), 3.00 (hept, J=6.6 Hz, 4H), 2.76 (t, J=5.9 Hz, 4H), 1.26 (t, J=7.6 Hz, 3H), 0.88 (d, J=6.6 Hz, 24H). The 1,3-bis(2-(diisopropylamino)ethyl)-2-ethyl-1H-imidazol-3-ium bis(fluorosulfonyl)imide can be an ionically associated combination as the positive charge of 1,3-bis(2-(diisopropylamino)ethyl)-2-ethyl-1H-imidazol-3-ium ionically associates (e.g., ionic bonding) with the negative charge of bis(fluorosulfonyl)imide to form a composition, which can be referred to as the T2 composition.

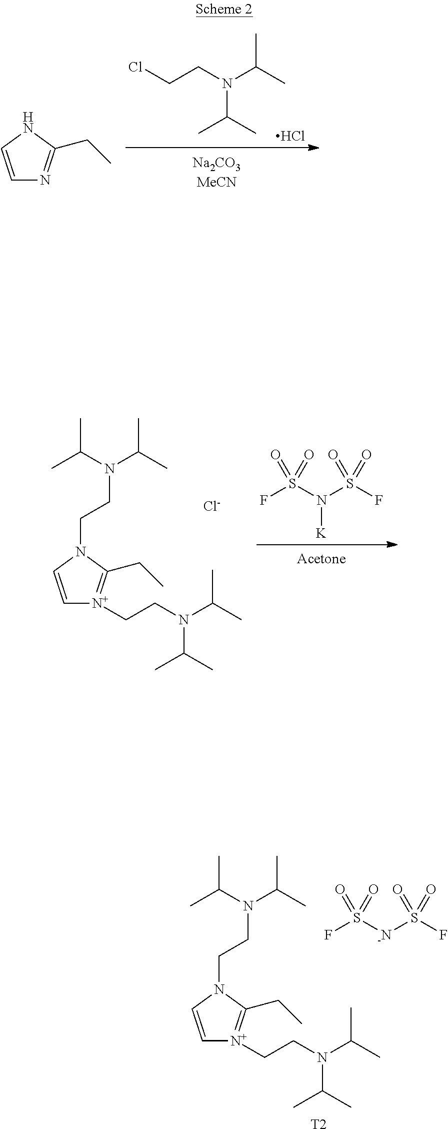

Preparation of a Polymer Solution

Preparation of a polymer solution was performed as follows. Accordingly, 95 mass parts n-butyl acrylate, 5 mass parts acrylic acid and 125 mass parts ethyl acetate were introduced into a stirring flask attached to a condenser that was equipped with a nitrogen gas inlet. The mixture was stirred at room temperature while introducing the nitrogen gas, for about 1 hour to remove oxygen from the reaction system. Then, 0.2 mass parts azobisisobutyronitrile (AIBN) were added, which increased the temperature of the resulting mixture to about 63°±2° C., and mixed/stirred for about 5-6 hours for polymerization. After stopping the reaction, an acrylic polymer-containing solution resulted, having a solid content of about 30%. The apparent molecular weight of the polymer solution (P1) was determined to be about 800,000 with a Tg (glass transition temperature) of about −50° C.

Preparation of Adhesive Sheet

An adhesive sheet was prepared by mixing the polymer solution described above with 0.01 gram of an epoxy crosslinking agent, such as N,N,N′,N′-tetraglycidyl-m-xylenediamine, per 100 gram of solid polymer solution, and combined with at least one of the ionic liquid compounds (e.g., 5.0 gm and/or 5 wt % imidazolium cation and/or bis(fluorosulfonyl)imide), described above, to obtain an electrically debondable adhesive compositions. The prepared compositions were coated/deposited upon a surface treated PET separator (release liner) [MRF38, made by Mitsubishi Chemical Corp., Japan], forming an adhesive composite layer at a thickness of about 150 μm (microns). The coated film was then heat dried at 130° C. for about 3 minutes. A second PET (Polyethylene terephthalate) separator (release liner) was then aligned over the exposed adhesive coating to obtain a layered sheet (PET separator/adhesive coating/PET separator) which was then aged/dried at 50° C. for about 20-24 hours and then stored under ambient conditions until needed.

Adhesive Ionic Composition Corrosive Test

Just prior to the application of the adhesive sheet to an aluminum film, the aforementioned release liner was removed. The adhesive sheet, as previously described above, was applied to the metallic surface of the aluminum film (50 nm-thick aluminum coated PET film [Toray Advanced Film, Tokyo, Japan]). The prepared adhesive-aluminum film was placed in a temperature and humidity benchtop chamber, set at 60° C./85% Relative Humidity (RH), 85° C./85% RH or 80° C./90% RH (ESPEC North America, [Hudsonville, Mich., USA], Criterion Temperature & Humidity Benchtop Model BTL-433) and were periodically checked at selected times (initially hourly). The interface between the adhesive and the aluminum foil was visually examined for an indication of corrosive degradation of the aluminum foil and/or dissolution of the metal in the selectively adherent adhesive and/or pitting of the aluminum foil. If corrosiveness was observed, the time was recorded and the sample was indicated as corrosive. The results are shown in Table 1, below. Here: no IL is the aluminum film without any ionic liquid; AS 110 is a prior ionic liquid; T1 is the composition from Example 1; and T2 is the composition from Example 2. Accordingly, the data shows the ionic compositions of T1 and T2 have superior resistance to corrosion.

TABLE 1

| No IL | AS 110 | T1 | T2 |
|---|---|---|---|
| >600 h | <3 h | >820 h | >820 h |

Adhesion Test

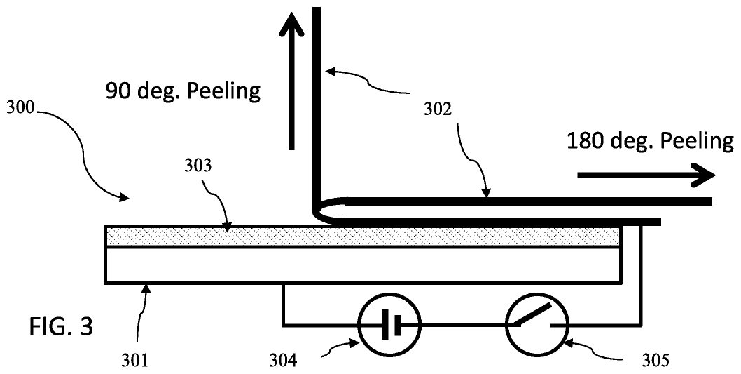

The testing for adhesion was done in the manner as described in Japanese Patent Publication No. JP 2017-095590 and/or WO2017/064918 and shown in FIG. 3.

As shown in FIG. 3, the selectively adhesive material 303 was coated upon a conductive substrate 301 of 25 mm wide and 100 mm long and laminated with another flexible conductive layer 302 (e.g., such as aluminum foil and/or metalized plastic film such as PET), which is 10 mm to 25 mm wide and 100 mm longer than 301 and by the application of rolling pressure, by 2 kg roller and roll press.

The bonding/de-bonding tester (Mark-10, Copiague, N.Y., USA, model ESM303 motorized tension/compression stand) was equipped with a Mark-10 force gauge (Series 7-1000) and had lower and upper clamps. The conductive substrate 301 was fixed onto the lower clamp and then electrically connected to the positive pole of a power supply 304 (Protek DC Power Supply 3006B). The top layer 302 was fixed to the upper clamp which is connected with the negative pole of the same DC power supply. This resulted in a configuration similar to FIG. 1. The power supply had an output range from 0 to 100 VDC. The moving/peeling speed was set at 300 mm/min.

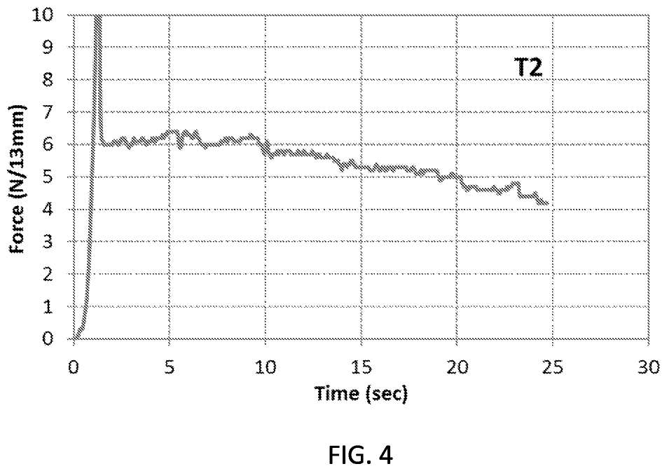

In a dynamic test, the voltage was applied a few seconds after the peeling or separation starts and the time and peeling strength readings from the force gauge are recorded by the data acquisition system (Mark-10 MESURgauge Plus). FIG. 4 shows the 180 deg. peeling strength evolution with time when a 10 VDC was applied to the selectively adhesive material 303 that is doped with the T2 composition of Example 2 with a concentration of 5 wt. %.

In a static de-bonding test, the sample was fixed on to the tester and connected to the power supply in the same way. The initial 180 deg. peeling was measured at the same peeling speed. Then peeling was stopped. A DC voltage (10 VDC for example) was applied for some time (10 second for example). And then the peeling strength was measured at the same peeling speed of 300 mm/min. For the same adhesive sample from the T2 composition of Example 2, the initial peeling strength is 6.0 N/cm; while the residual adhesion peeling strength is −4 after applying 10 VDC for 10 second.

### Definitions

By “substituted” as in “substituted alkyl,” “substituted aryl,” and the like, as alluded to in some of the definitions provided herein, is meant that in the alkyl, aryl, or other moiety, at least one hydrogen atom bound to a carbon (or other) atom is replaced with one or more non-hydrogen substituents.

When the term “substituted” appears prior to a list of possible substituted groups, it is intended that the term apply to every member of that group. For example, the phrase “substituted alkyl, alkenyl, and aryl” is to be interpreted as “substituted alkyl, substituted alkenyl, and substituted aryl.” Analogously, when the term “heteroatom-containing” appears prior to a list of possible heteroatom-containing groups, it is intended that the term apply to every member of that group. For example, the phrase “heteroatom-containing alkyl, alkenyl, and aryl” is to be interpreted as “heteroatom-containing alkyl, heteroatom-containing alkenyl, and heteroatom-containing aryl.”

As used herein, “optionally substituted” indicates that a chemical structure may be optionally substituted with a substituent group, such as defined herein. That is, when a chemical structure includes an atom that is optionally substituted, the atom may or may not include the optional substituent group, and thereby the chemical structure may be considered to be substituted when having a substituent on the atom or unsubstituted when omitting a substituent from the atom. A substituted group, referred to as a “substituent” or “substituent group”, can be coupled (e.g., covalently) to a previously unsubstituted parent structure, wherein one or more hydrogens atoms (or other substituent groups) on the parent structure have been independently replaced by one or more of the substituents. The substituent is a chemical moiety that is added to a base chemical structure, such as a chemical scaffold. As such, a substituted chemical structure may have one or more substituent groups on the parent structure, such as by each substituent group being coupled to an atom of the parent structure. The substituent groups that can be coupled to the parent structure can be any possible substituent group. In examples of the present technology, the substituent groups (e.g., R groups) can be independently selected from an alkyl, —O-alkyl (e.g. —OCH₃, —OC₂H₅, —OC₃H₇, —OC₄H₉, etc.), —S-alkyl (e.g., —SCH₃, —SC₂H₅, —SC₃H₇, —SC₄H₉, etc.), —NR′R″, —OH, —SH, —CN, —NO₂, or a halogen, wherein R′ and R″ are independently H or an optionally substituted alkyl. Wherever a substituent is described as “optionally substituted,” that substituent can also be optionally substituted with the above substituents.

The term “imidazolium” or “imidazole” refers to overall charged or uncharged ring system shown as follows:

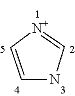

The use of the term “imidazolium cation” or “imidazole cation” refers to the “imidazolium” or “imidazole” having a positive charge, such as from at least one substituent.

The term amino refers to the overall charged or net uncharged chemical group, where the R group can be a substituent, such as the substituents described herein:

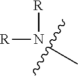

The terms “bis(fluorosulfonyl)imide” and/or “fluorosulfonylimide” refer to a heteroatom moiety, for example:

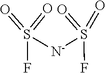

The term “alkyl” or “aliphatic” as used herein refers to a branched or unbranched saturated hydrocarbon group typically although not necessarily containing 1 to about 24 carbon atoms, such as methyl, ethyl, n-propyl, isopropyl, n-butyl, isobutyl, t-butyl, octyl, decyl, and the like, as well as cycloalkyl groups such as cyclopentyl, cyclohexyl, and the like. Generally, although again not necessarily, alkyl groups herein contain 1 to about 18 carbon atoms, or 1 to about 12 carbon atoms. The term “lower alkyl” intends an alkyl group of 1 to 6 carbon atoms. Substituents identified as “C₁-C₆ alkyl” or “lower alkyl” contains 1 to 3 carbon atoms, and such substituents contain 1 or 2 carbon atoms (i.e., methyl and ethyl). “Substituted alkyl” refers to alkyl substituted with one or more substituent groups, and the terms “heteroatom-containing alkyl” and “heteroalkyl” refer to alkyl in which at least one carbon atom is replaced with a heteroatom, as described in further detail infra. If not otherwise indicated, the terms “alkyl” and “lower alkyl” include linear, branched, cyclic, unsubstituted, substituted, and/or heteroatom-containing alkyl or lower alkyl, respectively.

The term “alkenyl” as used herein refers to a linear, branched or cyclic hydrocarbon group of 2 to about 24 carbon atoms containing at least one double bond, such as ethenyl, n-propenyl, isopropenyl, n-butenyl, isobutenyl, octenyl, decenyl, tetradecenyl, hexadecenyl, eicosenyl, tetracosenyl, and the like. Generally, although again not necessarily, alkenyl groups herein contain 2 to about 18 carbon atoms, or 2 to 12 carbon atoms. The term “lower alkenyl” intends an alkenyl group of 2 to 6 carbon atoms, and the specific term “cycloalkenyl” intends a cyclic alkenyl group, or having 5 to 8 carbon atoms. The term “substituted alkenyl” refers to alkenyl substituted with one or more substituent groups, and the terms “heteroatom-containing alkenyl” and “heteroalkenyl” refer to alkenyl in which at least one carbon atom is replaced with a heteroatom. If not otherwise indicated, the terms “alkenyl” and “lower alkenyl” include linear, branched, cyclic, unsubstituted, substituted, and/or heteroatom-containing alkenyl and lower alkenyl, respectively.

The term “alkynyl” as used herein refers to a linear or branched hydrocarbon group of 2 to 24 carbon atoms containing at least one triple bond, such as ethynyl, n-propynyl, and the like. Generally, although again not necessarily, alkynyl groups herein contain 2 to about 18 carbon atoms, or 2 to 12 carbon atoms. The term “lower alkynyl” intends an alkynyl group of 2 to 6 carbon atoms. The term “substituted alkynyl” refers to alkynyl substituted with one or more substituent groups, and the terms “heteroatom-containing alkynyl” and “heteroalkynyl” refer to alkynyl in which at least one carbon atom is replaced with a heteroatom. If not otherwise indicated, the terms “alkynyl” and “lower alkynyl” include linear, branched, unsubstituted, substituted, and/or heteroatom-containing alkynyl and lower alkynyl, respectively.

The term “alkoxy” as used herein intends an alkyl group bound through a single, terminal ether linkage; that is, an “alkoxy” group may be represented as —O-alkyl where alkyl is as defined above. A “lower alkoxy” group intends an alkoxy group containing 1 to 6 carbon atoms, and includes, for example, methoxy, ethoxy, n-propoxy, isopropoxy, t-butyloxy, etc. Substituents identified as “C₁-C₆ alkoxy” or “lower alkoxy” herein contain 1 to 3 carbon atoms, and such substituents contain 1 or 2 carbon atoms (i.e., methoxy and ethoxy).

The term “aryl” as used herein, and unless otherwise specified, refers to an aromatic substituent containing a single aromatic ring or multiple aromatic rings that are fused together, directly linked, or indirectly linked (such that the different aromatic rings are bound to a common group such as a methylene or ethylene moiety). Examples of aryl groups contain 5 to 20 carbon atoms, and aryl groups contain 5 to 14 carbon atoms. Exemplary aryl groups contain one aromatic ring or two fused or linked aromatic rings, e.g., phenyl, naphthyl, biphenyl, diphenylether, diphenylamine, benzophenone, and the like. “Substituted aryl” refers to an aryl moiety substituted with one or more substituent groups, and the terms “heteroatom-containing aryl” and “heteroaryl” refer to aryl substituent, in which at least one carbon atom is replaced with a heteroatom, as will be described in further detail infra. If not otherwise indicated, the term “aryl” includes unsubstituted, substituted, and/or heteroatom-containing aromatic substituents.

The term “aryloxy” as used herein refers to an aryl group bound through a single, terminal ether linkage, wherein “aryl” is as defined above. An “aryloxy” group may be represented as —O-aryl where aryl is as defined above. Examples of aryloxy groups contain 5 to 20 carbon atoms, and aryloxy groups contain 5 to 14 carbon atoms. Examples of aryloxy groups include, without limitation, phenoxy, o-halo-phenoxy, m-halo-phenoxy, p-halo-phenoxy, o-methoxy-phenoxy, m-methoxy-phenoxy, p-methoxy-phenoxy, 2,4-dimethoxy-phenoxy, 3,4,5-trimethoxy-phenoxy, and the like.

The term “alkaryl” refers to an aryl group with an alkyl substituent, and the term “aralkyl” refers to an alkyl group with an aryl substituent, wherein “aryl” and “alkyl” are as defined above. Examples of aralkyl groups contain 6 to 24 carbon atoms, and aralkyl groups contain 6 to 16 carbon atoms. Examples of aralkyl groups include, without limitation, benzyl, 2-phenyl-ethyl, 3-phenyl-propyl, 4-phenyl-butyl, 5-phenyl-pentyl, 4-phenylcyclohexyl, 4-benzylcyclohexyl, 4-phenylcyclohexylmethyl, 4-benzylcyclohexylmethyl, and the like. Alkaryl groups include, for example, p-methylphenyl, 2,4-dimethylphenyl, p-cyclohexylphenyl, 2,7-dimethyinaphthyl, 7-cyclooctylnaphthyl, 3-ethyl-cyclopenta-1,4-diene, and the like.

The term “cyclic” refers to alicyclic or aromatic substituents that may or may not be substituted and/or heteroatom containing, and that may be monocyclic, bicyclic, or polycyclic.

The terms “halo” and “halogen” are used in the conventional sense to refer to a chloro, bromo, and fluoro or iodo substituent.

The term “heteroatom-containing” as in a “heteroatom-containing alkyl group” (also termed a “heteroalkyl” group) or a “heteroatom-containing aryl group” (also termed a “heteroaryl” group) refers to a molecule, linkage or substituent in which one or more carbon atoms are replaced with an atom other than carbon, e.g., nitrogen, oxygen, sulfur, phosphorus or silicon, typically nitrogen, oxygen or sulfur. Similarly, the term “heteroalkyl” refers to an alkyl substituent that is heteroatom-containing, the term “heterocyclic” refers to a cyclic substituent that is heteroatom-containing, the terms “heteroaryl” and heteroaromatic” respectively refer to “aryl” and “aromatic” substituents that are heteroatom-containing, and the like. Examples of heteroalkyl groups include alkoxyaryl, alkylsulfanyl-substituted alkyl, N-alkylated amino alkyl, and the like. Examples of heteroaryl substituents include pyrrolyl, pyrrolidinyl, pyridinyl, quinolinyl, indolyl, pyrimidinyl, imidazolyl, 1,2,4-triazolyl, tetrazolyl, etc., and examples of heteroatom-containing alicyclic groups are pyrrolidino, morpholino, piperazino, piperidino, etc.

All other chemistry terms are defined as known in the art.

One skilled in the art will appreciate that, for the processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

All references recited herein are incorporated herein by specific reference in their entirety.

1. An adhesive composition comprising:
at least one imidazolium cation of Formula 1 and/or Formula 3: 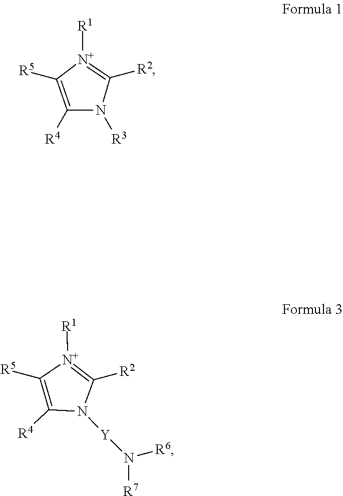
wherein:
R¹ is a hydrogen, C₁-C₃ alkyl, or an optionally substituted C₁-C₁₂ alkylamine,
R³ is a C₁-C₃ alkyl or an optionally substituted C₁-C₁₂ alkylamine,
R², R⁴, R⁵, R⁶, and/or R² are each independently a hydrogen or a C₁-C₃ alkyl, and
Y is a linker; and
at least one fluorosulfonylimide anion of Formula 2 and/or Formula 4: 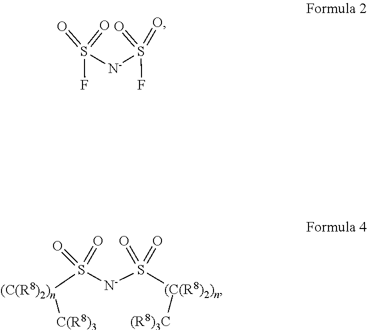
wherein:
each R⁸ is individually a hydrogen or a fluorine, and
n is an integer.

2. (canceled)

3. The adhesive composition of claim 1, wherein:
R¹, R², R⁴ and R⁵ are each independently a hydrogen, methyl, ethyl, or propyl;
Y is a C₁-C₁₂ alkyl; and
n is 0, 1, 2, 3, or 4.

4. The adhesive composition claim 1, wherein at least one of the R¹ or R³ is the following:

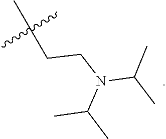 [SMILES: *CCN(C(C)C)C(C)C]

5. The adhesive composition claim 1, wherein the imidazolium cation is at least one of the following:

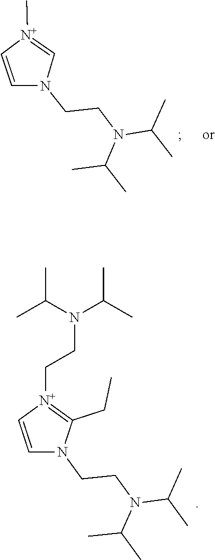

6. (canceled)

7. The adhesive composition of claim 1, further comprising a polymer containing the imidazolium cation and fluorosulfonylimide anion.

8.-9. (canceled)

10. The adhesive composition of claim 7, wherein the polymer comprises acrylic acid, C₁₋₁₄ hydrocarbyl acrylate, C₁₋₁₄ hydrocarbyl methacrylate monomers, or a combination thereof.

11. The adhesive composition of claim 10, wherein the polymer is crosslinked with N,N,N′,N′-tetraglycidyl-m-xylenediamine.

12.-15. (canceled)

16. The adhesive composition of claim 1, wherein the adhesive composition is configured to be selectively debondable under application of an electromotive force.

17. A method of preparing the adhesive composition of claim 7, the method comprising:
combining the fluorosulfonylimide anion, the imidazolium cation, and a polymer.

18. (canceled)

19. The method of claim 17, further comprising crosslinking the polymer before, during or after being combined with the fluorosulfonylimide anion and the imidazolium cation.

20. A method of adhering the adhesive composition of claim 1 to a substrate, the method comprising:
applying the adhesive composition to a first electrically conductive substrate; and
applying the adhesive composition to a second electrically conductive substrate such that the adhesive composition is between the first electrically conductive substrate and the second electrically conductive substrate.

21. (canceled)

22. An adhesive member comprising:
the adhesive composition of claim 1 formed into an adhesive layer; and
at least one release liner on at least one side of the adhesive layer.

23. The adhesive member of claim 22, comprising a release liner on each side of the adhesive layer.

24. A selectively adhesive material comprising the adhesive composition of claim 16, wherein the application of an electromotive force to the selectively adhesive material reduces the adhesion of the selectively adhesive material.

25. A selectively debondable structure comprising a selectively debondable layer of the selectively adhesive material of claim 24, wherein the selectively debondable layer is disposed between a first electro-conductive surface and a second electro-conductive surface.

26. (canceled)

27. The selectively debondable structure of claim 25, further comprising a power supply that is in electrical communication with at least one of the first electro-conductive surface and the second electro-conductive surface, creating a closeable electrical circuit.

28. The selectively debondable structure of claim 27, wherein the first electro-conductive surface comprises an electro-conductive material and the second electro-conductive surface comprises an electro-conductive material.

29. (canceled)

30. The selectively debondable structure of claim 28, wherein the electro-conductive material comprises a metal, a mixed metal, an alloy, a metal oxide, a composite metal, a conductive plastic or a conductive polymer.

31. The selectively debondable structure of claim 30, wherein the electro-conductive material comprises an electro-conductive metal, wherein the electro-conductive metal comprises aluminum.

32. (canceled)

33. The selectively debondable structure of claim 25, wherein the selectively adhesive material has a reduced corrosive effect upon the first and second electro-conductive surfaces.

34. (canceled)
